(19) United States
(12) Patent Application Publication
(10) Pub. No.: US 2004/0153410 A1
(43) Pub. Date: Aug. 5, 2004

(54) Anonymous payment system and method

(76) Inventors: Jerome Nootebos, Surrey (CA); Mark Evans, Surrey (CA)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/472,711

(22) PCT Filed: Mar. 21, 2002
(86) PCT No.: PCT/CA02/00399

(51) Int. Cl. G06F 17/60

(52) U.S. Cl. 705/44

(57) ABSTRACT

An anonymous payment system according to the invention provides for the distribution of randomly generated prepaid PINs associated with a value, wherein such PINs can be used to purchase goods and services from registered merchants. The PINs may be purchased from terminals and may be activated without the necessity of disclosing any personal information.

This application claims the benefit of U.S. Provisional Application No. 60/277,263, filed Mar. 21, 2001, the entire disclosure of which is herein incorporated by reference.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to payment systems used on the Internet, and particularly to such payment systems that allow users to purchase goods or services anonymously.

### BACKGROUND

Related art includes a number of different payment systems available that allow one entity (i.e. an individual or a business) to make payments to another entity. The most common payment systems in use are paper bills and coins, debit and credit cards, cheques, and travelers' cheques. New systems, many still in trial stage, include home banking, smart cards or on-line payment methods using the Internet and intranets. Such payment systems are limited in the situations in which they can be used and therefore, it is necessary to use a number of payment systems in parallel (for example cash with a local retailer and credit cards on the Internet).

Paper bills and coins are anonymous in use, and can be used freely from entity to entity (i.e. no registration is required). However, such a system requires a physical transfer of the coins or bills.

Debit and credit cards provide some protection against loss and fraud. However, transactions using such cards are not anonymous and can only be used to pay merchants (i.e. entities who exchange goods or services for value) who are registered with the appropriate debit or credit organization. In addition, small payments (e.g. less than $5) are often not accepted by the merchants.

Cheques are a useful means to pay an entity. The use of cheques also protect the user against loss (for example, the cheque can be canceled). However, as cheques are a paper based system, they need to be physically transported to the recipient's bank which can be a multiple-step and time-consuming process. In addition, funds are often not immediately available to the recipient, who may have to wait until the cheque clears. Cheque payments also lack anonymity.

Home banking as a payment system replaces a physical chequing system with an electronic cheque, shortening the “clearance” time for the recipient to receive the funds. However, other disadvantages with respect to cheques, including the lack of anonymity, remain.

Smart card based systems use smart cards as a medium of storage for value. The smart cards act in conjunction with a smart card reader to allow payment. Therefore, a physical contact must be established between the smart card user (the payer) and the payee (who must have an appropriate card reader). There are a number of different underlying technological approaches available for smart card based payment system.

A typical smart card system is anonymous and is modeled after the paper bill and coin system. Using such a system, value can be transferred from entity to entity freely and without restriction. However, these systems require a physical connection between the smart card and a smart card reader.

Other smart card systems are not anonymous and are limited to a payment from an entity to a registered merchant. Also, often the merchant can not use the transferred funds immediately, as the funds must first clear the banking system.

Available Internet payment systems are in early development or field trial stages. Some of these systems offer micro payment options (some use $1 as the smallest transaction, others use $0.01). However, these payment systems are limited, and do not offer the user anonymity. Furthermore, most of these systems only handle payments from an entity to a registered merchant.

Therefore, from a user's point of view the payment systems currently available (as well as those in development) have shortcomings. A payment system should fulfill the following criteria:

1. Payments can be made via the Internet, telecommunications networks, and digital TV (as well as other such electronic environments).

2. The system could be used universally to pay any entity and to receive funds from any entity, anywhere in the world.

3. The payment system can provide for multiple currencies.

4. Payments can be freely used as soon as they are received regardless of the physical distance between the payer and payee.

5. The system is anonymous to users and the privacy of the individuals is protected.

6. The system can recognize certain illegal transactions and the transaction history can be made transparent to allow the tracking of these illegal transactions (i.e. it is a policy option not a technical limitation to set the rules of revealing a transaction history).

7. Transportation of payments across a network is secure utilizing the latest encryption technologies.

8. Integrity of national and international banking systems is guaranteed (irregularities in the payment system are detected and can not enter the banking system and therefore have no impact on the money supply of a country).

9. Receipts for payments are provided.

Payment systems in use today do not fulfil all or most of these criteria. However, the payment system according to the invention does.

### SUMMARY OF THE INVENTION

The system according to the invention provides for Internet commerce between entities by means of a pre-paid PIN preferably available via terminals placed at convenience stores and other locations. The PINs may be purchased through a device that dispenses the randomly generated PINs on paper similar to that used with lottery tickets, or on biodegradable vouchers that can be thrown away without hurting the environment, or on cards, or other printed matter known in the art. The user need only have a means of remembering the PIN number received. Preferably, the user will feel satisfied that he is not damaging the environment and at the same time feel comfortable that the PIN is confidential to him. The payment system according to the invention also comprises at least three components that can be prepared in web programming languages known in the art. These components are labeled the confidential identification (“CID”) creation component, the activation component and the transaction component. Together these components provide an Internet payment system allowing for the anonymous flow of commerce on the Internet.

The confidential identification (or CID) creation component allows a user to protect his personal information and at the same time allows the payment system to recognize that entity as a user (without requiring personal information from that user). The CID enables a user to accumulate, in an account associated with the CID, the value associated with any number of PINs. The last PIN entered in association with the same CID, will be associated with the sum of the previous PINs entered. The CID is a static value selected by the user which will not change unless the user elects otherwise.

The activation component takes the randomly generated PIN and the CID and activates the PIN so that the user may use the value associated with the PIN to buy products and services from registered merchants. The two hardware components that provide this are a main server, running the activation component source code (the source code can be written in any web programming language known in the art) and a database server. The activation component receives a PIN and CID and runs a screening process. If the screening process is successfully completed, the PIN is “activated” and can be used for purchases. If the screening process is not completed, the user is given an appropriate message depending on the error and the activation component does not activate the PIN. If the user has more then one PIN to enter then each PIN is entered one at a time. The last PIN entered will be associated with a value equivalent to the sum of all of the previous PINs entered in the session (and any value already associated with the CID).

The transaction component takes a PIN (and preferably the associated CID), an order value and a merchant account number and processes a transaction from a registered merchant's website. The transaction, if successfully completed, adds the order value to the merchant's account and deducts the order value from the user's account. Three hardware components interact for this purpose, a main web server running the transaction component source code (the source code can be written in any web programming language), a database server, and a merchant server. The information to complete the transaction is submitted to the merchant server which then sends the transaction information, using encryption methods known in the art, to the main server running the transaction component source code. The main server then runs a series of screening processes. If the screening processes are completed satisfactorily, the order value is deducted from the user's account and deposited into the merchant's account. If the screening processes are not satisfactorily completed, the transaction is canceled and an error message is returned. On completion of a successful transaction a message is sent to the merchant server allowing the merchant website to display the results of the transaction.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a flow chart showing the process by which a user creates a CID;

FIG. 2 is a flow chart showing the process by which a user activates a pre-paid PIN;

FIG. 3 is a flow chart showing the process by a transaction is completed; and

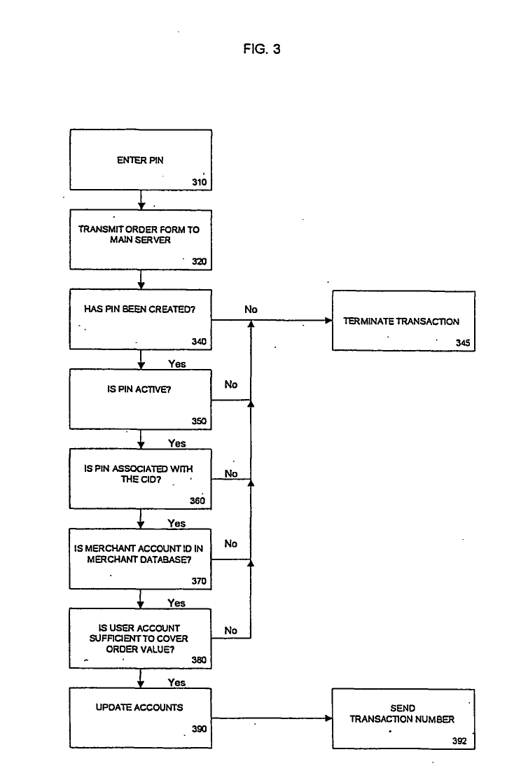

FIG. 4 is a block diagram showing the components of a payment system according to the invention.

### DETAILED DESCRIPTION OF PREFERRED EMBODIMENTS

The following terms will have the following meanings throughout this specification and attached claims:

“Activation” means altering a value associated with a PIN such that the PIN can be used for purchases, for example, by changing a field in the PIN Database associated with a PIN thereby such that the PIN can be used to purchase goods or services from registered merchants via the payment system.

“CID” means “Confidential Identification Number” and is a string of characters used as a password selected by a user. In an embodiment of the invention, the CID is used in the PIN activation process, a nd optionally, the transaction process. In the disclosed embodiment, the CID is associated with a user account, a PIN and optionally, some additional identifying information.

“PIN” means a string of characters that are initially randomly generated. A user purchases a PIN associated with a value. In an embodiment of the invention, once activated a PIN can be used to purchase goods and services from registered merchants using the payment system.

“User Account” means an account with a balance associated with a CID, which in turn is associated with the most recent PIN entered with the CID.

“Merchant Account” means an account associated with a registered merchant to receive payment via the payment system.

“Component” means the software and hardware necessary to complete certain processes.

“Payment System” means the software and hardware necessary to implement the system described herein. The payment system will be administrated by an administrator, an entity who will control the main server and the database server.

“Entity” means a corporation, business, person or other legal entity that conducts commerce.

“Registered Merchant” means an entity engaged in the sale of goods or services that has registered to receive payment via the payment system.

“Server” means the computer (or computers) and necessary software to carry out the processes described herein.

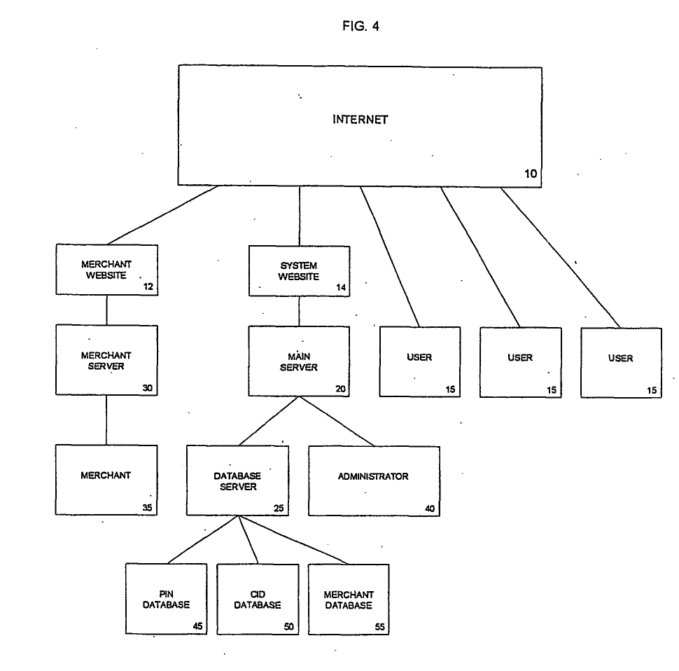

As seen in FIG. 4, the payment system works via the Internet 10. Connected to the Internet are users 15, who will purchase and activate the PINs, and purchase goods and services from merchants 35. Main server 20 is also connected to the Internet 10 to facilitate transactions between users 15 and merchant 35. Merchant 35 has a merchant server 30 running a merchant website 12 by which merchant 35 sells its goods and services. Users 15 and merchant 35 interface with the payment system via system website 14 which is run by main server 20. Main server 20 records and retrieves information from database server 25, which contains a CD database 50, a PIN database 45 and a merchant database 55. An administrator 40 manages the main and database servers 20, 25, provides the PINs and pays merchant 35.

The main components making up the payment system are the CID creation component, the activation component and the transaction component, although smaller components, such as the merchant registration component are also present. The present system allows users 15 to purchase goods and services anonymously by means of a pre-paid randomly generated PIN. For example, at present credit card numbers provide no anonymity for the user when purchasing online. Furthermore, credit card numbers, if stolen, can be used to do a great deal of damage to their owner. From the merchant perspective, credit cards are also used for fraud that such merchants must be on guard for. By providing a pre-paid randomly generated PIN to users for use with merchants, fear and apprehension of online purchasing will be reduced, and at the same time concerns about fraud will be minimized.

The confidential identification (CID) creation component is a key component to the anonymity of the payment system. The CID is a secret password created by a user. The CID allows the payment system to identify the user without requiring personal information. The CID also allows a user to accumulate the value of any amount of PINs. The CID should be known only by the user, the administrator of the payment system and no one else as the CID is the way by which the payment systems keeps track of the balance of a particular user.

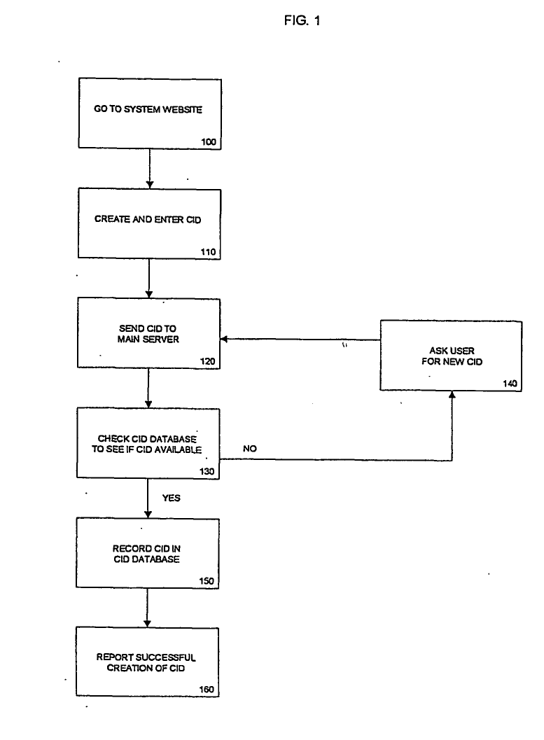

As seen in FIG. 1, the process for creating a CID begins after a user has acquired one or more randomly generated PINs from an authorized dealer, the user then goes to a payment system website (preferably provided to the user with the PIN) at the main server to activate the PINs for use in purchasing goods and services via the Internet (step 100). If the user has not yet provided a CID to the main server, the user must first create one. The CID is a secret password used to activate the PINs and associate the value thereof to an account. The user then enters the proposed CID into a designated input box at the website (step 110). The proposed CID password is sent to the main server for processing (step 120). The main server checks the CID database to see if the CID is already taken (step 130). If the CID is already in the CID database the user is given a message stating that he must select a new CID (step 140). This process is repeated until a CID is provided that is not already in the CID database. If the CID entered does not exist in the CID database, the server records the new CID into the CID database (step 150). The user is given a welcoming message and a notification of the successful creation of the CID (step 160).

Using the above process, the CID is provided without any personal information at all. In an alternative embodiment, when creating the CID, the user is prompted to answer questions from a randomly selected question database. The questions are preferably not about personal information, but are easy to remember questions that may be used by the administrator to verify the user associated with a CID, should the need arise (for example if a user forgets his CID). Sample questions might include “What is your favorite television program?” or “What is your favorite animal?”. The questions and their answers associated with a CID are recorded in the CID database.

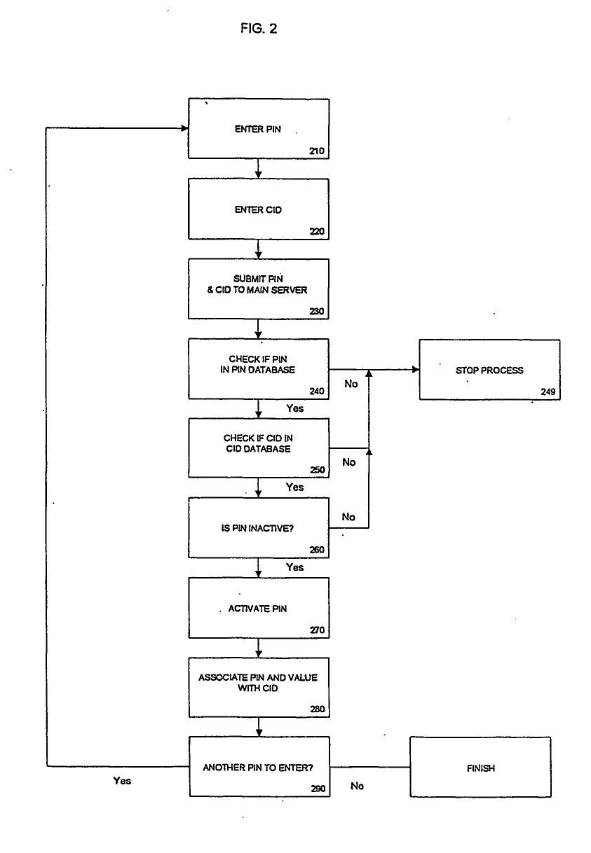

The activation component uses a PIN and a CID to activate the PIN (as seen in FIG. 2). After a user has created a CID, the user can then enter a PIN for activation.

PINs may preferably be obtained by purchasing them from a number of sources. For example, in a preferred embodiment, PINs may be purchased from terminals. The user may select the value associated with the desired PIN, and the terminal will then create the PIN using a secure random number generator, and send an encrypted message to the main server with the PIN and associated value with the PIN. The main server will store the PIN and value in the PIN database, and indicate that the PIN is inactive. The PIN will then be dispensed to the customer using a receipt, or card, or other medium known in the art.

In an alternative embodiment PINs may be sold using a point of sale (POS) terminal operated by a clerk. The clerk will take a payment for a value by a user, and will enter into a POS terminal the amount received. The POS terminal will randomly generate or obtain a randomly generated PIN associated with that value, and dispense the PIN to the user.

To activate the PIN, the user goes to the system website, and enters the PIN into the designated input box (step 210). The user then enters his CID into the designated input box (step 220). The PIN and CID are then submitted to the main server for processing (step 230). The server checks to see if the PIN is recorded in the PIN database (step 240). If there is a record of the PIN, the server will continue the activation process. If there is no record of the PIN, the server will stop the activation process (step 245) and provide an error message stating that the PIN entered is invalid. In an alternative embodiment, if a number of invalid PINs are entered, the administrator may “freeze” the CID to prevent the user from entering and activating further PINs (on the assumption the user is “fishing” for a valid PIN number). The administrator may also ask the “questions” associated with the CID to see determine if the person using the CID is the person authorized to do so.

The main server then checks to see if the CID is recorded in the CID database (step 250). If the CID is so recorded, the main server continues the activation process. If the CID is not recorded, the main server will stop the activation process (step 245) and provide an error message stating that the user has not provided a valid CID. The main server then checks the PIN record to determine if the PIN entered is inactive (step 260). If the boolean value associated with the status field in the PIN record is “0” the PIN is inactive and the activation process will continue. If the boolean value next to the pin number in the status column is “1”, then the PIN has already been activated and the activation process is stopped (step 245) and an error message provided stating that the PIN has already been activated.

The main server then changes the status ID boolean value from “0” to “1” thereby activating the PIN (step 270). Each PIN can only be activated once. The main server then associates the PIN and the value associated with the PIN with the CID in the CID database (step 280). If there is already a PIN and value associated with the CID, the main server updates the PIN recorded in the CID database with the new PIN entered and adds the previous value to the value associated with the new PIN. This ensures the new PIN is activated and is associated with the entire value of the CID when the user uses the PIN to make online purchases. Only one PIN (the most recently entered) will be associated with a CID at a given time. If the user has more then one PIN the user repeats the process for each PIN. The last PIN entered will be associated with the value of all the previous PINs entered in that session and the beginning value (if any) associated with the CID prior to the session.

The above method of PIN activation ensures that the user remains anonymous and creates confidence that they are not being data mined. In alternative embodiments of the invention, the user has the option, when creating the CID, to provide personal information, which may incur some benefits to the user (for instance if the user forgets his CID, it would be easier to connect that user to his account with some personal information).

The transaction component allows commerce to take place between users and registered merchants online. Every day thousands of transactions are made online via credit cards. Although credit cards provide a quick and easy way to purchase products and services online, they also come with a security risk. The transaction component acts as a secure payment system between a given merchant website and the users. After a user has reached the check out portion of an e-commerce enabled merchant website provided by a registered merchant, the user will have the option of entering an activated PIN (and optionally a CID). At this point, the merchant server will have the final value of the purchase (the “order value”). In the coding of this web page in the merchant website are the merchant deposit number and the order value.

The user begins by entering a PIN into a designated input form (step 310). Within the input form is the merchant account ID and the order value. The merchant server then transmits the encrypted order form, including the PIN, the order value and the merchant account ID to the main servers for processing (step 330). The merchant server will not receive the unencrypted PIN and CID, as this information will be encrypted as it is entered on the form using means known in the art.

The main servers examine the PIN database to see if the PIN entered has been created (step 340). If the PIN is not in the PIN database then the transaction is canceled (step 345) and an error message is sent to the merchant's web server indicating the reason why the transaction could not be completed. If the PIN is in the PIN database, the transaction process continues. The main server then examines the PIN database to see if the PIN entered is active (step 350). If the PIN is inactive, then the transaction is cancelled (step 345) and a message is sent to the merchant's web server indicating the reason why the transaction could not be completed (pursuant to the code chart). If the PIN is active then the transaction process continues.

The main server then checks the PIN in the CID database to see if the PIN entered is associated with a CID (step 360). If the PIN is not associated with a CID, then the transaction is cancelled (step 345) and a message is sent back to the merchant's web server indicating the reason why the transaction could not be completed. If the PIN is associated with a CID, then the transaction process continues. The main server then checks to see if the merchant account ID is recorded in the merchant database (step 370). If the merchant account ID is not in the database, then an error message is sent to the merchant's web server indicating that the merchant account ID does not exist. If the merchant account ID does exist, then the transaction process continues.

If the PIN was entered with the CID, the main server only has to check to determine if the PIN and CID are so associated in the CID database.

The main server then checks the user account associated with the PIN and CID against the order value (step 380). If the user account does not have enough value to complete the transaction (i.e. the value is less than the order value), then the transaction is cancelled and a message is sent to the merchant's web server indicating the reason why the transaction could not be completed. If the balance associated with the PIN is greater then the order value, then the transaction process continues.

The main server then deducts the order value from the account associated with the PIN and CID, and updates the PIN database and the CID database to indicate the remaining balance associated with the PIN; and uses the merchant account ID to determine the value associated with that ID in the merchant database and then adds the order value to that balance associated with the merchant account ID (step 390).

The main server now sends a message to the merchant's web server to indicate that the transaction was successful and instructs the website to display a transaction number for both the merchant server and the user. The user may have to provide information to the merchant in order to receive the good or service. Such information will not be transmitted to the main server, which will identify the user only through the CID and PIN, and will not receive personal information about the user.

When a merchant creates an account to use the payment system they are provided software (for example, in HTML, XML or Java) which is placed in the code for the web page handling the transactions. This software allows the merchant to decipher the messages that will be sent to the merchant's web server from the main servers, and encrypts and sends messages to the main server containing the user's CID and PIN.

The merchant account creation process enables a business or individual to accept payment via the payment system. In one embodiment of the invention, only reputable merchants (perhaps having a certain track record of sales) are entitled to register merchant accounts. In alternative embodiment, anyone, including individuals can create a merchant account to receive funds from users.

To register, the merchant creates an account by filling out a form at the system website and submits the information to the main servers for processing. The main server then verifies that the necessary information has been provided, and if the information entered is adequate, records the data as a record in the merchant database and provides the merchant with a randomly generated merchant account ID, necessary to accept transfers via PINs. The main server then provides the software for the merchant to place in the merchant website along with instructions on how to do so. Preferably, when completing a transaction, the main server will check to see if this software has been altered, and if it has, cancel the transaction. The merchant account ID will be a hidden value in the software provided. The merchant then places the software as instructed into merchant's website.

Merchants may be reimbursed for value in the merchant account IDs by one of two means. In one embodiment merchants may arrange to be paid by the administrator on a regular basis (i.e. weekly, monthly, or even daily). At the end of each period, the administrator will transfer to the merchant associated with a merchant account ID, the balance in the associated account and will reset the account to 0. In an alternative embodiment, the merchant may transfer value from the merchant account ID to a user account by providing the PIN and CID information. The administrator may charge the merchants by retaining a percentage of the money otherwise payable to the merchant or that is received by the merchant in each transaction.

The payment system according to the invention allows individuals to pay each other as they would using currency by purchasing a PIN, and giving the PIN to another party (before activating such PIN). The PIN can be communicated to the other party via phone, email or by giving the other party the receipt or card on which the PIN is printed.

A preferred embodiment of the payment system employs the PHP web programming language. The PHP language advantages include that it is a license-free language under the GNU Agreement, which along with the Apache web server, combine to make a powerful yet versatile web-based commerce program. PHP also provides session management features and quick and easy database access. The session management feature provides a way to control large numbers of users accessing the main website while allowing the main server to keep track of the users and their activities. Every time a user logs in to the system website he may be traced with a user ID. The user ID is an identification number given to each user that creates a CID. The user ID allows the main server to record transaction data associated with the CID. This allows the administrator to cooperate with any criminal investigations or similar activities.

In another embodiment of the invention, the payment system may be able to return “lost PINs”. The creation and dispensing of PINs will be tracked by the main server, to the extent that the administrator will be able to determine where, when and for how much a PIN was distributed. Should a PIN be lost, the user who purchased the PIN may make a claim for a PIN purchase for a particular value, at a particular time and place. Should no other user validate the PIN, or make a competing claim within a defined time period (for example a year), then the administrator may provide the PIN to the user making the claim.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method for a user to provide payment to a merchant comprising:
(a) providing a prepaid PIN to the user, said PIN associated with a first value;
(b) activating said PIN by associating said first value with a user account, said user account associated with said value without requiring personal information from said user;
(c) providing a deposit number to the merchant, said deposit number associated with a merchant account;
(d) means for the user to provide said activated PIN to an interface to approve payment of an order value to said second account; and
(e) transferring said order value from said first account to said second account.

2. The method of claim 1, further comprising means for the user to select a CID comprising a string of characters, said CID associated with said user account, said PIN and said first value, said CID selectable by said user without the disclosure of personal information of said user.

3. The method of claim 2 wherein the user provides no personal information when activating said PIN or selecting said CID.

4. The method of claim 3 wherein the user provides said CID to said interface.

5. The method of claim 4 wherein said interface is a website operated by the merchant.

6. The method of claim 5 wherein said PIN is provided by a terminal.

7. The method of claim 6 wherein said PIN is randomly generated by said terminal before being provided to the user, and said terminal transmits said PIN to a server for recordation in a database.

8. The method of claim 7 wherein said PIN is initially recorded in said database as inactive.

9. A system for providing payment on the Internet comprising:
(a) a server providing an interface whereby a user may establish a CID and a user account, and activate a PIN associated with a value;
(b) a database having a record of said PIN, and said CID, and a record of said value as a balance in said user account;
(c) a second database having a record of a merchant, an account associated with said merchant and a merchant account number;
wherein when said user makes a purchase of a good or service from said merchant at a website operated by said merchant, said purchase having an order value, said website sends said activated PIN and said CID entered at said website by said user, and said merchant account number and order value to said server; and said server confirms the association of said PIN and said CID, said server deducts said order value from said user account and adds said order value to said merchant account.

10. The system of claim 9 wherein a portion of said order value is transferred to an administrator of the system.

11. The system of claim 9 wherein said first database has no personal information about said user.

12. The system of claim 11 wherein an administrator retains a portion of said order value from the value added to said merchant account.

13. The system of claim 11 wherein said user may activate a plurality of PINs, each of said PINs associated with a value.

14. The method of claim 1, further comprising:
(f) sending a transaction number confirming said transfer to said merchant and said user.
